(19) United States
(12) Patent Application Publication
(10) Pub. No.: US 2003/0188011 A1
(43) Pub. Date: Oct. 2, 2003

(54) Method and apparatus to distribute data

(76) Inventors: Nikhil M. Deshpande, Beaverton, OR (US); Jeffrey G. Yarne, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/109,937

(22) Filed: Mar. 29, 2002

(51) Int. Cl. G06F 15/16

(52) U.S. Cl. 709/238; 709/236

(57) ABSTRACT

Briefly, in accordance with an embodiment of the claimed subject matter, a method and an apparatus to distribute data is provided, wherein the method includes examining the payload portion of the electronic data to determine whether and where to transmit the electronic data.

### BACKGROUND

Today, there exists many electronic devices for performing computing tasks such as calendaring, word processing, creating and sharing presentation documents, digital imaging, email, etc. Some of these devices include desktop computers, laptop computers, personal digital assistants (PDAs), two-way pagers, cellular phones, etc. These electronic devices have many different capabilities such as, for example, differences in terms of performance, storage, display size, system and network capabilities, portability, applications supported, etc. For example, a cellular phone may have less processing and storage capability compared to a laptop computer.

Generally, many of the above mentioned electronic devices have the capability of wireless connectivity. Accordingly, a two-way pager, cellular phone, PDA, or laptop may have the ability to receive data wirelessly. However, because of the different capabilities of these devices, some devices may not have the capability to process received data of all types. For example, a cellular phone may not have the capability to receive and process an email message containing a graphic image file attachment.

Thus, there is a continuing need for alternate ways to distribute data between various computing devices.

### BRIEF DESCRIPTION OF THE DRAWINGS

The subject matter regarded as the invention is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a block diagram illustrating a computing system in accordance with an embodiment of the claimed subject matter;

FIG. 2 illustrates data in accordance with an embodiment of the claimed subject matter;

FIG. 3 illustrates a display layout of status information in accordance with an embodiment of the claimed subject matter;

FIG. 4 is a flow chart illustrating a method to distribute data in accordance with an embodiment of the claimed subject matter; and

FIG. 5 is a block diagram illustrating a device manager in accordance with an embodiment of the claimed subject matter.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the claimed subject matter may be practiced without these specific details. In other instances, well-known methods, procedures, components and circuits have not been described in detail so as not to obscure the claimed subject matter.

Embodiments of the claimed subject matter may include an apparatus for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), flash memory, magnetic or optical cards, or any other type of media suitable for storing electronic instructions and data.

Embodiments of the claimed subject matter are not described with reference to any particular programming language. It will be appreciated that a variety of programming languages may be used to implement the teachings of the claimed subject matter as described herein. For example, high-level procedural, object-oriented, assembly, or machine programming languages may be used to implement the claimed subject matter.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

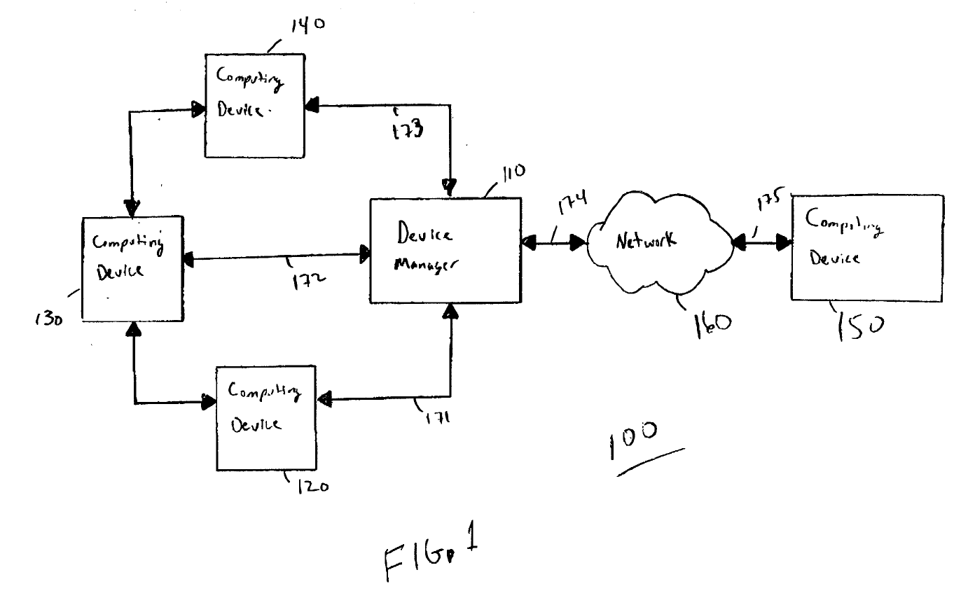

Turning to FIG. 1, an embodiment of a computing system 100 is illustrated. Although the scope of the claimed subject matter is not limited in this respect, computing system 100 may include a device manager 110 connected to computing devices 120, 130, and 140. In addition, device manger 110 may be coupled to a computing device 150 via a network 160. Although the scope of the claimed subject matter is not limited in this respect, computing devices 120, 130, 140, and 150 and device manager 110 may be electronic computing devices that may operate as a personal digital assistant (PDA), a two-way pager, a cellular phone, a portable computer, a desktop computer, a workstation, or a server.

In this example, device manager 110 may be coupled to computing devices 120, 130, and 140 via bi-directional communication links 171, 172, and 173, respectively. In addition, device manager 110 may be coupled to network 160 via a bi-directional communication link 174 and computing device 150 may be coupled to network 160 via a bi-directional communication link 175. Bi-directional communication links 171-175 may be either wireless or wired communication links.

Although the scope of the claimed subject matter is not limited in this respect, examples of network 160 may include a local area network (LAN), a wide area network (WAN), an intranet, the internet, a cellular network, or any network for distributing electronic data or messages. Network 160 may comprise one or more computing devices (e.g., one or more servers), one or more cellular base stations, etc. In one embodiment, device manager 110 may communicate with computing devices 120, 130, and 140 using a private network such as, for example, an intranet, and device manager 110 may communicate with computing device 150 using a public network such as, for example, the internet. In this embodiment, device manager 110 may have a public electronic address and computing devices 120, 130, and 140 may have private electronic addresses. In some embodiments, the electronic address may be an Internet Protocol (IP) address.

In some embodiments, device manager 110 may include functionality to operate as a router that receives electronic data from computing device 150 and distributes this data to computing devices 120, 130, and 140. Although the scope of the claimed subject matter is not limited in this respect, electronic data may be distributed between device manager 110 and computing devices 120, 130, and 140 using a private network such as, for example, a proximity based network, an ad hoc network, a peer-to-peer network, or a LAN. As an example, a private wireless network may be established using ultra wideband (UWB), Bluetooth, or IEEE 802.11 that allow devices within a short range (e.g., between approximately one to approximately 100 meters) of each other to link and interconnect to share and distribute data. In alternate embodiments, device manager 110 and computing devices 120, 130, and 140 may establish a private network using a wired Ethernet LAN.

As another example, a proximity network between device manager 110 and computing devices 120, 130, and 140 may be established using Universal Plug and Play (UPnP). Universal Plug and Play (UPnP) is a standard that may use Internet and Web protocols to enable device manager 110 and computing devices 120, 130, and 140 to be plugged into a network and automatically know about each other, i.e., automatically obtain status information about each other. For example, with UPnP, when a user plugs a device into the network, the device may configure itself, acquire a Transmission Control Protocol/Internet Protocol (TCP/IP) address, and use a discovery protocol based on the Internet's Hypertext Transfer Protocol (HTTP) to announce its presence on the network to other devices.

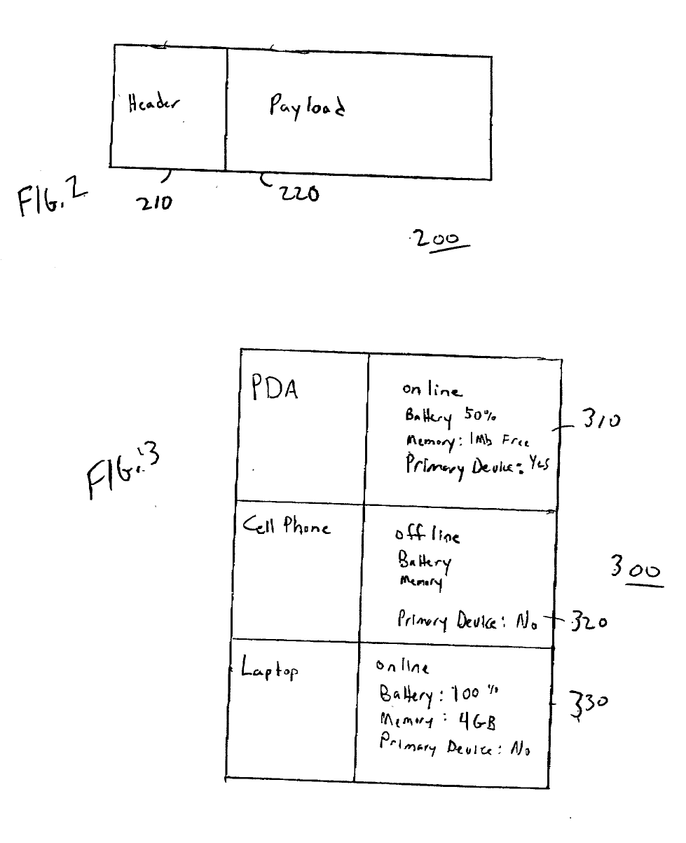

In some embodiments, a message may be transmitted from computing device 150 to device manager 110 using network 160. FIG. 2 illustrates an example of electronic data 200 that may be transmitted from computing device 150 to device manager 110. Data 200 may also be routed from device manager 110 to computing devices 120, 130, and 140. In alternate embodiments, data 200 may be routed from computing devices 120, 130, or 140 to computing device 150 via device manager 110 and network 160.

In one embodiment, data 200 may be a complete message, or in alternate embodiments, data 200 may be a portion of a message, wherein the message may be divided into a plurality of packets and data 200 may be one packet of the plurality of packets. Data 200 may include a header portion 210 and a payload portion 220. Header portion 210 may be a region of data 200 that precedes payload portion 220 and may contain overhead information such as, for example, source and destination addresses of data 200, error checking information, the date and time when data 200 was created, and/or the size of data 200. Payload portion 220 may be referred to as the content portion of data 200 and may be a region of data 200 that follows header portion 210.

In one embodiment, data 200 may be a graphic image file, wherein header portion 210 may contain information such as, for example, the date the file was created, the date the file was last updated, and the file's size. In this embodiment, payload portion 210 may contain the binary data that represents the graphic image. In an alternate embodiment, data 200 may be an email message and header portion 210 may be the part of the message that may include the electronic mail address of the sender and recipient(s), the message priority level, and the time and date when the message was created. Payload portion 220 may be the part of the message that contains the body of the email message. For example, payload portion 220 may contain a block of American standard code for information interchange (ASCII) text. In addition, payload portion 220 may contain an attachment file, wherein the attachment file may be, for example, a graphic image file or an audio file. If data 200 is a packet of data, then header portion 200 may contain source and destination information of the packet, packet size or length, and whether there are other packets of data associated with this packet.

As discussed above, device manager 110 (FIG. 1) may be adapted to operate as a router. Device manager 110 may also be adapted to receive status information from computing devices 120, 130, and 140.

Although the scope of the claimed subject matter is not limited in this respect, status information may include information such as the characteristics or capability of computing devices 120, 130, and 140. For example, the status information may include information identifying the type of computing device, e.g., whether the computing device is a PDA, cellular phone, laptop computer, etc. In addition, other examples of status information include presence information, processing capability (e.g., processor speed), applications supported (e.g., graphic image viewer, graphic image editor, word processor, spreadsheet, email, etc.), battery status (e.g., percentage charged), or memory status (e.g., storage capability/availability, memory available to support operating system execution and applications during execution). In alternate embodiments, the status information may also include network connectivity information, e.g., whether the device is “online” or “offline.” In other words, the status information may include information indicating whether the device is connected or linked to a network that may include device manager 110 and computing devices 120, 130, and 140.

In some embodiments, device manager 110 may receive user input. In these embodiments, a user may indicate a primary or priority device selected to receive data from device manager 110 and this information may be stored in device manager 110. Accordingly, a hierarchy system may be implemented between device manager 110 and computing devices 120, 130, and 140 wherein, for example, messages may be routed to a primary device of choice designated by the user. If the designated primary device is not available or is not capable of processing the message, then, the message may be transmitted to another computing device within the network.

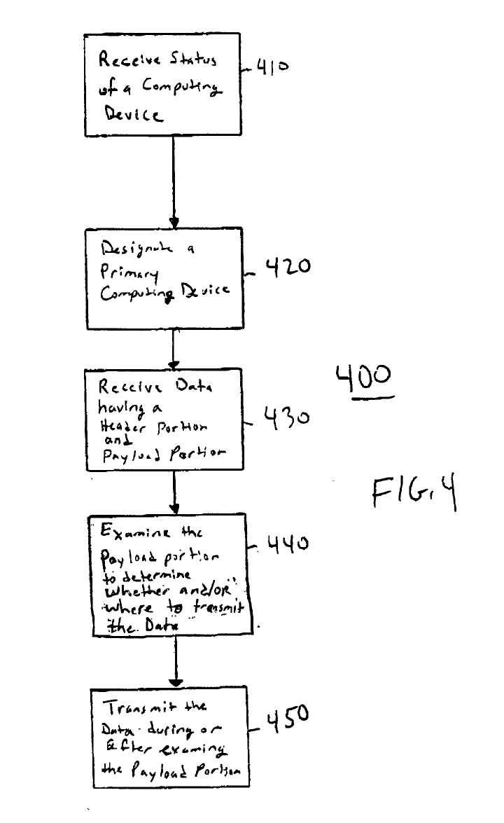

Device manager 110 may include a display to display status and hierarchy information. FIG. 3 illustrates an embodiment of a display layout 300 of status information for computing devices 120, 130, and 140 that may be displayed by device manager 110. For example, computing device 120 may be a PDA, computing device 130 may be a cell phone, and computing device 140 may be a laptop computer. The corresponding status information of the PDA, cell phone, and laptop may be displayed in areas 310, 320, and 330, respectively. In addition, in this example, hierarchy information that indicates which device is the primary device to receive data from device manager 110, may be displayed in areas 310, 320, and 330. In the embodiment illustrated in FIG. 3, the PDA is designated as the primary device.

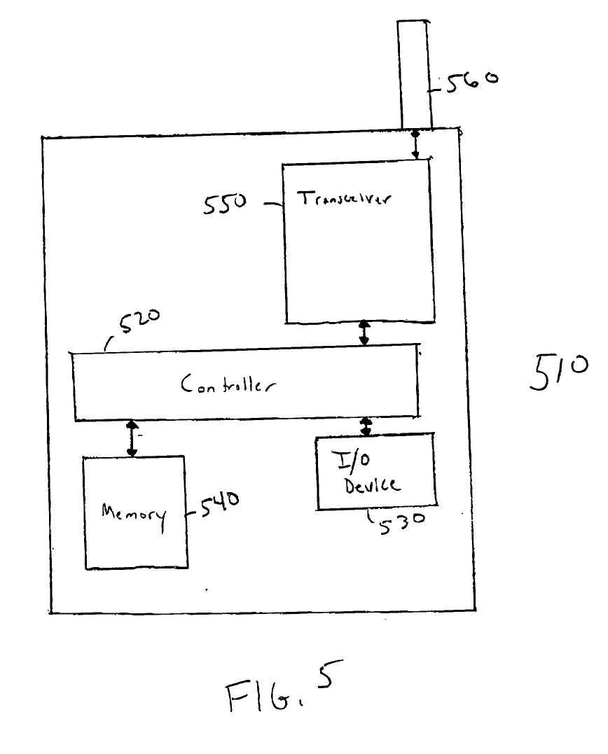

Turning to FIG. 4, a method 400 to distribute data in accordance with an embodiment of the claimed subject matter is described. Generally, this method may be implemented using computing system 100 (FIG. 1), and more particularly, using device manager 110 (FIG. 1). For example, device manager 110 may include circuitry, software, or a combination of circuitry and software to implement the method described in FIG. 4.

This embodiment may begin with receiving status information of computing devices 120, 130, and 140 (block 410). The status information may be transmitted from computing devices 120, 130, and 140 and may be stored in device manager 110. In alternate embodiments, a user may be able to designate a computing device (e.g., computing device 120) as the primary device to receive data from device manager 110 (block 420). This primary device hierarchy information may be stored in device manager 110.

Device manager 110 may receive an electronic message or data (e.g., data 200 of FIG. 2) having a header portion and a payload portion (block 430). Device manager 110 may be adapted to examine the header portion and the payload portion of the data.

Device manager 110 may be adapted to route the data based on the payload portion of the data. For example, device manager 110 may examine the payload portion of the data to determine whether and/or where to transmit the data from device manager 110 to one or all of computing devices 120, 130, and 140 (block 440). In alternate embodiments, device manager 110 may transmit the data to the designated primary computing device when status information of the primary computing device indicates that the device is capable of processing and storing the payload portion of the data. In other words, device manager 110 may evaluate the payload or content portion of the data and/or status information of the primary computing device such as, for example, network connectivity, battery status, processing speed, memory availability, applications supported, to determine whether and/or where to transmit the data to the designated primary computing device.

As an example, device manager 110 may include computer processes or electronic hardware to determine if a designated primary computing device is enabled to or capable of processing the data. If so, then device manager 110 may transmit the data to one of computing devices 120, 130, or 140 during or after examining the payload portion of the data (block 450). In some embodiments, device manager 110 may transmit the data to the designated primary computing device (e.g., computing device 120) during or after examining the payload portion of the data. In alternate embodiments, device manager 110 may transmit the data to another computing device (e.g., computing devices 130 or 140) within the network, and may use status information of the other computing devices within the network to determine whether and/or where to transfer or route the data.

It should be noted that the sequence of the actions described in FIG. 4 is not a limitation of the claimed subject matter. For example, in alternate embodiments, device manager 110 may receive status information after receiving the electronic data.

Turning to FIG. 5, an embodiment of a device manager 510 in accordance with an embodiment of the claimed subject matter is described. Device manager 510 may be an example of device manager 110 (FIG. 1). In this example, device manager 510 may be a wireless device such as, for example, a cellular phone, that may communicate with computing devices 120, 130, 140, and 150 and network 160 of computing system 100 (FIG. 1) using wireless communication links. Device manager 110 may include a controller 520, an input/output (I/O) device 530 (e.g. a keypad, a display), a memory 540, and a transceiver 550 that may be connected to an antenna 560, although the scope of the present invention is not limited to embodiments having any or all of these components.

Controller 520 may comprise, for example, digital circuitry, one or more microprocessors, digital signal processors, microcontrollers, or the like. Memory 540 may be used to store messages or data transmitted to or by device manager 510. In addition, memory 540 may be adapted to store hierarchy information and status information of other computing devices (e.g., computing devices 120, 130, and 140). Memory 540 may also optionally be used to store instructions that are executed by controller 520 during the operation of device manager 510, and may be used to store user data. Memory 540 may be provided by one or more different types of memory. For example, memory 540 may comprise a volatile memory (e.g., any type of random access memory) and/or a non-volatile memory (e.g., a flash memory).

I/O device 530 may be used by a user to, for example, receive data from a user and/or display information to the user. Device manager 510 may use a transceiver 550 with antenna 560 to transmit and receive messages to and from a wireless communication network with a radio frequency (RF) signal.

As may be appreciated, device manager 510 may be used to implement the method illustrated in FIG. 4. For example, in one embodiment, memory 540 may store a computer program that when executed by controller 520 may examine status information, hierarchy information, and/or the header and payload portions of an electronic message to determine whether and/or where to transmit the data. The electronic message may be received using transceiver 550 and antenna 560. I/O device 530 may be a display to display status and hierarchy information in the format illustrated in FIG. 3. Alternatively, I/O device may be a keypad that may be used to receive user input such as, for example, input designating a primary computing device.

Although the scope of the claimed subject matter is not limited in this respect, device manager 510 may use one of the following communication protocols to transmit and receive messages: Bluetooth, ultra wideband, IEEE 802.11, Code Division Multiple Access (CDMA), cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, or third generation (3G) systems like Wide-band CDMA (WCDMA), CDMA-2000.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method to transmit electronic data having a header portion and a payload portion, comprising:
examining the payload portion of the electronic data to determine where to transmit the electronic data; and
transmitting the electronic data to a device based on the examining of the payload portion of the electronic data.

2. The method of claim 1, further comprising transmitting the electronic data to the device when status of the device indicates that the device is capable of processing the payload portion of the electronic data.

3. The method of claim 1, further comprising transmitting the electronic data from a second device to the device when information stored in the second device indicates that the device is to receive the electronic data.

4. The method of claim 1, wherein transmitting comprises transmitting the electronic data during or after examining the payload portion of the electronic data.

5. The method of claim 1, wherein transmitting comprises transmitting the electronic data using a wireless network.

6. The method of claim 1, wherein transmitting comprises routing the electronic data using a private network.

7. The method of claim 1, further including receiving the electronic data at a second device using a public network and wherein transmitting comprises transmitting the electronic data from the second device to the device using a private network.

8. An article comprising a storage medium having stored thereon instructions, that, when executed by a computing platform, result in:
examining electronic data having a header portion and a payload portion; and
determining which device of at least two devices to transfer the electronic data based on the payload portion of the data.

9. The article of claim 8, wherein the instructions, when executed, further result in:
receiving status of a device of the at least two devices and wherein examining comprises;
examining the status of the device; and
transferring the electronic data to the device during or after examining the status of the device and the payload portion of the electronic data.

10. The article of claim 9, wherein transmitting includes routing the electronic data using a private network.

11. An apparatus, comprising: circuitry adapted to route an electronic message having a header portion and a content portion based on the content portion of the electronic message, wherein the electronic message is routed from the circuitry to a device.

12. The apparatus of claim 11, wherein the circuitry is further adapted to transmit the electronic message from the circuitry after examining the content portion of the electronic message.

13. The apparatus of claim 11, further comprising a transceiver coupled to the circuitry and adapted to receive the electronic message and adapted to receive status of the device, wherein the circuitry is adapted to route the electronic message to the device using the transceiver after examining the status of the device and after examining the content portion of the electronic message.

14. The apparatus of claim 13, wherein the transceiver is adapted to receive the electronic message using a public network and is adapted to route the electronic message to the device using a private network.

15. A system to distribute data having a header portion and a content portion, comprising: a wireless device adapted to examine the content portion of the data to determine whether to transmit the data from the wireless device.

16. The system of claim 15, wherein the wireless device is further adapted to receive the data using a public network.

17. The system of claim 15, further including a second wireless device adapted to receive the data from the wireless device.

18. The system of claim 17, wherein the second wireless device is further adapted to receive the data from the wireless device using a private network.

19. The system of claim 17, wherein the wireless device is further adapted to transmit the data to the second wireless device after examining the content portion of the data and after examining status of the second wireless device.

20. The system of claim 17, wherein the wireless device is further adapted to transmit the data to the second wireless device after determining if the second electronic device is capable of processing the content portion of the data.

21. A method to transfer electronic data having a header portion and a payload portion, comprising: determining which device of at least two devices to transfer the electronic data based on the payload portion of the data.

22. The method of claim 21, further comprising: further comprising transferring the electronic data to a device of the at least two devices when status of the device indicates that the device is capable of processing the payload portion of the electronic data.

23. The method of claim 22, wherein transferring comprises transmitting the electronic data using a wireless network.

24. The method of claim 22, wherein transferring comprises routing the electronic data using a private network.
